(19) United States
(12) Patent Application Publication
(10) Pub. No.: US 2008/0260294 A1
(43) Pub. Date: Oct. 23, 2008

(54) IMAGE STORAGE DEVICE, PHOTOGRAPHING APPARATUS, AND IMAGE STORAGE DEVICE CONTROL METHOD

(76) Inventor: Toshihiro OGATA, Tokyo (JP)

Correspondence Address: John C. Pokotylo;STRAUB & POKOTYLO, Bldg. B, 2nd Floor, 620 Tinton Avenue, Tinton Falls, NJ, 07724-3260, US

(21) Appl. No.: 12/107,553

(22) Filed: Apr. 22, 2008

(30) Foreign Application Priority Data
Apr. 23, 2007 (JP) 2007-113325

(51) Int. Cl. G06K 9/54

(52) U.S. Cl. 382/305

(57) ABSTRACT

An image storage device includes an image information storing section for storing an image file; a processing section for executing an application which uses an image file; a use-by-application specifying section for specifying a use of an image file by the application; a transmitting section for transmitting an image file to an external apparatus; a remaining-capacity-of-medium detecting section for detecting the remaining capacity of the image information storing section; a deletion specifying section for specifying an image file which has already been transmitted to an external apparatus by the transmitting section and which is not specified to be used by the application, as a deletion target; and a deleting section for, when the remaining storage capacity of the image information storing section is a predetermined amount or less, deleting the image file specified as a deletion target from among image files.

This application claims the benefit of Japanese Application No. 2007-113325 filed in Japan on Apr. 23, 2007, the contents of which are incorporated herein by this reference.

### BACKGROUND OF THE INVENTION

1. Field of the Invention

The present invention relates to an image storage device, a photographing apparatus and an image storage device control method, and more particularly, to an image storage device and a photographing apparatus which have a function of transmitting an image file stored in a storage medium to an external apparatus and a function of processing the image file, and a method for controlling the image storage device.

2. Description of the Related Art

Conventionally, there has been widely spread a photographing apparatus, such as a so-called digital camera, which performs optical/electrical conversion processing of an optical image formed by a photographing/optical system by an optical/electrical conversion device such as an image pickup device to acquire a subject image as an electrical image signal, and generates a digital image data file (hereinafter referred to simply as an image file) constituted by image data obtained by converting the image signal to digital data and various information data and the like related to the image signal (hereinafter referred to as related information).

Such a photographing apparatus is generally configured to include a display device for displaying an image based on the generated image file, an image storage device for storing the image file in a storage medium or the like.

In a photographing apparatus having a conventional image storage device, the storage capacity of an image storage medium or the processing power for processing an image file are limited. Therefore, there is configured a system in which an image file stored in the image storage device is transmitted to an external apparatus having a sufficient storage capacity, processing power and the like, for example, an external apparatus such as an image file processing apparatus like a small-sized computer and other image storage devices so that various processings for display, printing and the like of an image based on the transmitted image file can be performed in the external apparatus via dedicated application software, or the transmitted image file can be stored in a mass storage device provided for the external apparatus.

In this case, by further transmitting the image file for which the various processings have been performed to a display device, a printing apparatus or the like, the external apparatus realizes various functions such as a function of reproducing and displaying an image on the display device or a function of printing an image by the printing apparatus.

In the system configured as described above, free storage capacity in a recording medium on the photographing apparatus side is secured by, after transmitting an image file from the photographing apparatus side to the storage medium (image storage device) on the external apparatus side, deleting the image file on the photographing apparatus side.

Accordingly, for example, in the system disclosed in Japanese Patent Laid-Open No. 2006-115146, after an image file is transmitted from a photographing apparatus to a server apparatus which is an external apparatus, the image file is automatically deleted from a storage medium on the photographing apparatus side, and, on the server apparatus side, the received image file is registered with and stored in a storage medium on the server apparatus side.

Thus, a user of the photographing apparatus can use the photographing apparatus for photographing without caring about the free storage capacity of the storage medium on the photographing apparatus side.

On the other hand, there has been recently spread such a photographing apparatus that a liquid crystal display (LCD) device, which is a display device, is large-sized, the processing power of various electronic circuits is improved, and, in addition, an inexpensive mass storage medium or the like is provided.

Accordingly, in such a photographing apparatus, it is possible to, without transmitting an image file acquired by a photographing operation and stored in a storage medium to an external apparatus, perform various processings of the image file for display, printing and the like of an image with the use of processing circuits of the photographing apparatus itself. Furthermore, the photographing apparatus is provided with a mass storage medium which makes it possible to perform a photographing operation to acquire and store a new image file while a lot of image files are held in the storage medium without being deleted, and it is further provided with a liquid crystal displace (LCD) device which is a display device having a display area with a size enough to appreciate an image or visually perform various processing operations on the screen.

Due to the situation as described above, it is not often to delete a stored image file from a storage medium in a recent photographing apparatus. However, it is not rare to transmit an image file stored in a storage medium on the photographing apparatus side to an external apparatus because the image file is an important file or it is to be shared by others. Though the storage capacity of a storage medium which can be held by a photographing apparatus has been becoming large in size, the upper limit necessarily exists. Therefore, it is not possible to avoid the situation that there is no more free storage capacity in the storage medium.

Accordingly, for example, in the photographing apparatus disclosed in Japanese Patent laid-Open No. 2000-209536, information about a transmission state, a transmission destination and the like is managed by giving a state mark indicating a transmitted state to an image file which has been transmitted to an external apparatus, and, when there is no free storage capacity in a storage medium, the image file to which the transmitted state mark is given, among image files stored in the storage medium, is targeted by deletion.

Thus, since it is possible to manage a transmission state, a transmission destination and the like of an image file stored in a storage medium, it is possible to prevent an unnecessary operation such as repeatedly transmitting an image file. Furthermore, when the free storage capacity of the storage medium decreases, an image file which has been transmitted to an external apparatus is automatically presented as a deletion target. Therefore, it is possible to perform deletion without caring about whether or not to perform deletion, and it is not necessary to care about the free storage capacity at the time of performing photographing.

In a recent photographing apparatus, it is possible to perform various processing of an image file for display, print and the like of an image, with the use of the processing circuits of the photographing apparatus itself, as described above.

In this case, when image display processing is performed, display information which specifies a desired display format (information which specifies rotational display, negative-positive converted display, and calendar display format) and the like are added to the image file as related information.

Furthermore, when printing processing is performed, related information about printing conditions including information about link with other image files (including template images and the like) used when image synthesis processing and the like are performed, information to the effect that printing is to be performed, the number of prints and various instruction information about printing, and the like is added to the image file.

Standards for the related information added to an image file include, for example, the DPOF (Digital Print Order Format) standard, the PictBridge standard, the PRINT Image Matching standard, the Exif standard including the ExifPrint standard and the like.

As described above, in a recent photographing apparatus, a lot of related information about an image file acquired by a photographing operation and stored in a storage medium exists, and there exist various means for managing and operating the related information.

### SUMMARY OF THE INVENTION

An image storage device according to the present invention includes: an image information storing section for storing an image file; a processing section for executing an application which uses an image file stored in the image information storing section; a use-by-application specifying section for specifying a use of an image file stored in the image information storing section by the application; a transmitting section for transmitting an image file stored in the image information storing section to an external apparatus; a remaining-capacity-of-medium detecting section for detecting the remaining storage capacity of the image information storing section; a deletion specifying section for specifying an image file which has already been transmitted to an external apparatus by the transmitting section and which is not specified to be used by the application, as a deletion target; and a deleting section for, when the remaining storage capacity of the image information storing section is a predetermined amount or less, deleting the image file specified as a deletion target from among image files stored in the image information storing section.

An photographing apparatus according to the present invention includes: a photographing section for photographing a subject and generating an image signal; an image information storing section for storing an image file constituted by an image signal acquired from the photographing section and related information into a storage medium; a processing section for executing an application which uses an image file stored in the image information storing section; a use-by-application specifying section for specifying use of an image file stored in the image information storing section by the application; a transmitting section for transmitting an image file stored in the image information storing section to an external apparatus; a remaining-capacity-of-medium detecting section for detecting the remaining storage capacity of the image information storing section; a deletion specifying section for specifying an image file which has already been transmitted to an external apparatus by the transmitting section and which is not specified to be used by the application, as a deletion target; and a deleting section for, when the remaining storage capacity of the image information storing section is a predetermined amount or less, deleting the image file specified as a deletion target from among image files stored in the image information storing section.

A control method for controlling an image storage device which has the image information storing section of the present invention and a processing section for executing application software includes: a use specifying step of giving an image file stored in the image information storing section, use specification information which specifies the image file to be used by application software executed by the processing section; a transmitting step of transmitting an image file stored in the image information storing section to an external apparatus: a transmission history giving step of giving the image file transmitted to the external apparatus at the transmitting step, transmitted information indicating that the image file has been transmitted; a remaining-capacity-of-medium detecting step of detecting the remaining storage capacity of the image information storing section; a first deleting step of, when the remaining storage capacity of the image information storing section is a predetermined amount or less, deleting an image file which has the transmitted information given at the transmission history giving step and which is not given the use specification information; a specification releasing step of deleting the use specification information from an image file stored in the image information storing section; and a second deleting step of deleting the image file from which the use specification information has been deleted at the specification releasing step and to which the transmitted information is given.

The benefits of the inventions will be further apparent from next detailed description.

### BRIEF DESCRIPTION OF THE DRAWINGS

FIG. 1 is a block configuration diagram showing the outline of the internal configuration of a photographing apparatus including an image storage device of a first embodiment of the present invention;

FIG. 2 is a diagram conceptually showing the file structure of an image file generated by the photographing apparatus in FIG. 1;

FIG. 3 is a diagram conceptually showing the contents of a directory table in the header portion of the image file shown in FIG. 2;

FIG. 4 is a flowchart showing the flow of deletion prohibition registration processing in the photographing apparatus in FIG. 1;

FIG. 5 is a flowchart showing the flow of deletion prohibition release processing in the photographing apparatus in FIG. 1;

FIG. 6 is a flowchart showing the flow of image file transfer processing in the photographing apparatus in FIG. 1;

FIG. 7 is a flowchart showing the flow of image file transfer processing in a photographing apparatus including an image storage device of a second embodiment of the present invention;

FIG. 8 is a flowchart showing the flow of photographing operation processing in the photographing apparatus including the image storage device of the second embodiment of the present invention;

FIG. 9 is a flowchart showing the flow of image file transfer processing in a photographing apparatus including all image storage device of a third embodiment of the present invention;

FIG. 10 is a diagram showing an attribute list file generated by a photographing apparatus including an image storage device of a fourth embodiment of the present invention;

FIG. 11 is a diagram showing a deletable image file list file generated by the photographing apparatus including the image storage device of the fourth embodiment of the present invention;

FIG. 12 is a flowchart showing the flow of image file transfer processing in the photographing apparatus including the image storage device of the fourth embodiment of the present invention; and

FIG. 13 is a flowchart showing the flow of photographing operation processing in the photographing apparatus including the image storage device of the fourth embodiment of the present invention.

### DETAILED DESCRIPTION OF THE PREFERRED EMBODIMENTS

The present invention will be described below by embodiments with reference to drawings.

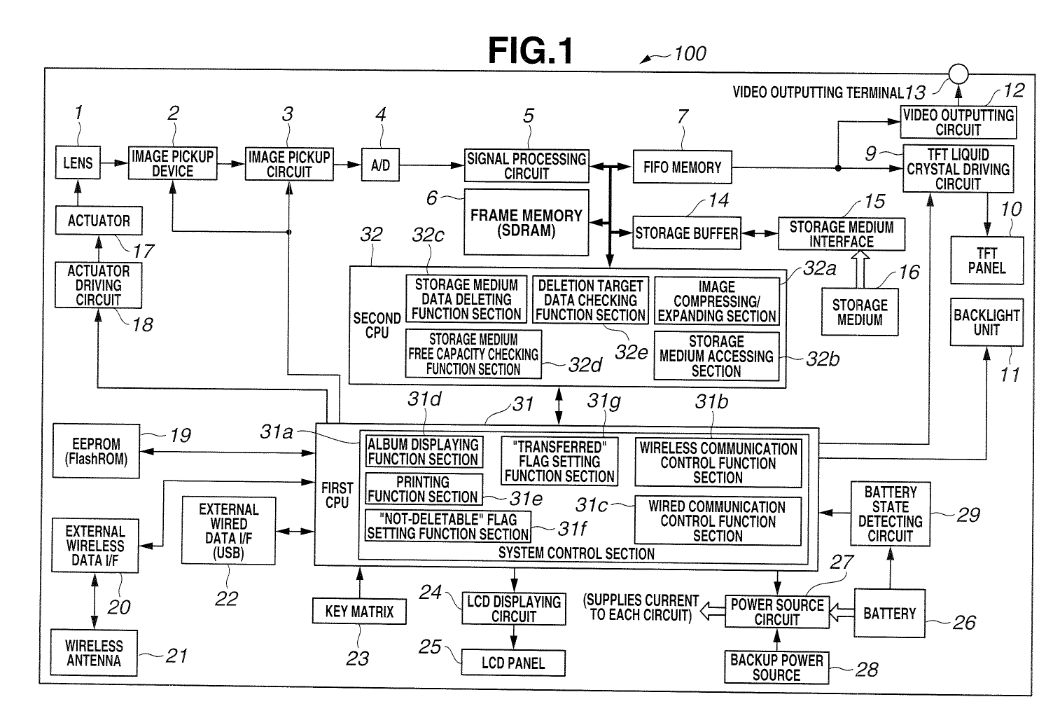

FIG. 1 is a block configuration diagram showing the outline of the internal configuration of a photographing apparatus including an image storage device of a first embodiment of the present invention.

An image storage device of the present embodiment is included in a photographing apparatus having photographing means which is photographing section for photographing a subject, acquiring an image signal and generating an image file, and the image storage device is configured to have an image information storing section for converting the image signal and related information acquired by the photographing apparatus into data and storing the data in a storage medium as an image file. That is, the image information storage device is configured to have the storage medium, the image information storing section, and the image information storage device functions as image information storing means in the photographing apparatus.

That is, the photographing apparatus configured to include the image storage device of the present embodiment is a photographing apparatus such as a so-called digital camera (hereinafter referred to simply as a photographing apparatus) which is configured to include: photographing means for receiving an optical image of a subject formed by a photographing/optical system constituted by an optical lens and the like, by an optical/electrical conversion device such as an image pickup device, acquiring an electrical image signal by performing optical/electrical conversion processing of the optical image, and generating a digital image data file (hereinafter referred to simply as an image file) which is constituted by image data obtained by converting the image signal to digital data and various information data related to the image signal (hereinafter referred to as related information); displaying means for displaying an image based on the image file generated by the photographing means; image information storing means (an image storage device) for storing the image file in a storage medium or the like; communication means provided with a wired communication function and a wireless communication function for performing data communication between the photographing apparatus and an external apparatus to send/receive the image file; and the like.

Specifically, the external apparatus which performs communication of data such as an image file with the photographing apparatus using the communication means (wired or wireless) includes an image reproduction apparatus or an image processing apparatus, such as a small-sized computer, an external storage device, a photographing apparatus having a different image storage device, and an image printing apparatus such as a printer.

That is, specifically, a photographing apparatus 100 including the image storage device of the present embodiment is mainly configured by a lens 1, an image pickup device 2, an image pickup circuit 3, an A/D converter (shown simply as A/D in FIG. 1) 4, a signal processing circuit 5, a frame memory 6, a FIFO memory 7, a TFT liquid crystal driving circuit 9, a TFT panel 10, a backlight unit 11, a video outputting circuit 12, a video outputting terminal 13, a storage buffer 14, a storage medium interface (hereinafter referred to as a storage medium I/F) 15, a storage medium 16, an actuator 17, an actuator driving circuit 18, an external wired data interface (hereinafter referred to as an external wired data I/F) 22, a key matrix 23, an LCD displaying circuit 24, an LCD panel 25, a battery 26, a power source circuit 27, a backup power source 28, a battery state detecting circuit 29, a first CPU 31, a second CPU 32, an EEPROM (Flash ROM) 19, an external wireless data interface (hereinafter referred to as an external wireless data I/F) 20, a wireless antenna 21, and the like, as shown in FIG. 1.

The lens 1 is provided to form an optical subject image on the light receiving surface of the image pickup device 2.

The image pickup device 2 is a device which receives the optical subject image formed by the lens 1, performs optical/electrical processing of the optical subject image and outputs an electrical image signal. As the image pickup device 2, a solid-state image pickup device capable of high-speed reading, for example, a CCD (charge-coupled device), a CMOS (complementary metal oxide semiconductor) and other various types of image pickup devices can be applied.

The image pickup circuit 3 is an electronic circuit which receives the output signal from the image pickup device 2 and performs various analog signal processings of the image signal.

The A/D converter 4 is a circuit for receiving an analog-form image signal outputted from the image pickup circuit 3 and converting the image signal into a digital-form image signal.

The signal processing circuit 5 is a circuit which receives the digital-form image signal outputted from the A/D converter 4 and performs various digital signal processings.

The frame memory 6 is temporary storing means for receiving the image signal processed by the signal processing circuit 5 and temporarily storing the processed image signal and various data and the like related to the image signal. As the frame memory 6, for example, a semiconductor storage device such as an SDRAM is applied.

In the photographing apparatus 100, the main part of the photographing means for photographing a subject, acquiring an image signal and generating an image file is configured by the lens 1, the image pickup device 2, the image pickup circuit 3, the A/D converter 4, the signal processing circuit 5, the frame memory 6 and the like described above.

The FIFO memory 7 is a memory provided to temporarily store an image signal therein when the image signal is outputted to various display devices.

The TFT liquid crystal driving circuit 9 is a circuit which receives an image signal outputted from the FIFO memory 7 and controls the TFT panel 10.

The TFT panel 10 is a displaying section for displaying an image based on an image signal or various information in the photographing apparatus 100 under the control of the TFT liquid crystal driving circuit 9, and a TFT panel capable of performing color display is used therefor.

The backlight unit 11 is provided on the back side of the TFT panel 10 to illuminate the TFT panel 10 from the back side thereof.

The video outputting circuit 12 is a circuit for receiving an image signal from the FIFO memory 7, converting the image signal to, for example, an NTSC format video signal, and outputting the video signal to an external display device and the like connected to the video outputting terminal 13 via the video outputting terminal 13.

The video outputting terminal 13 is a connecting terminal for connecting a signal line, such as a video cable, which electrically connects the photographing apparatus 100 and an external display device and the like.

In the photographing apparatus 100, the main part of the displaying means for displaying an image based on an image file generated by the photographing means is configured by the FIFO memory 7, the TFT liquid crystal driving circuit 9, the TFT panel 10, the backlight unit 11 and the like described above.

The storage buffer 14 is a buffer (temporary storage area) used when an image signal or the like temporarily stored in the frame memory 6 is stored in the storage medium 16 as image data or when image data is read from the storage medium 16 and temporarily stored in the frame memory 6.

The storage medium I/F 15 is a circuit for controlling processing for storing image data and the like in the storage medium 16 processing for reading image data and the like from the storage medium 16, and the like.

The storage medium 16 is a non-volatile storage medium for storing image data and other various data, for example, a thin-plate-shaped or card-shaped memory card. As the storage medium 16, there are storage media in various forms, for example, a storage medium which can be detachably attached to equipment such as the photographing apparatus 100 and a storage medium which is fixed to an electrical circuit inside equipment such as the photographing apparatus 100. An storage medium in any form is applicable to the photographing apparatus 100.

The main part of the image storage device, which is the image information storing means for storing an image file (image data and related information data of the image data) and the like generated by the photographing means into the storage medium 16 as data in a predetermined form, is configured by the storage buffer 14, the storage medium I/F 15, the storage medium 16 and the like described above.

The actuator 17 is a driving source for driving the lens 1 to perform an autofocus operation or a zooming operation.

The actuator driving circuit 18 is a circuit which controls to drive the actuator 17 on the basis of control by the first CPU 31.

The main part of lens driving means for performing an autofocus adjusting (autofocus (AF)) operation or a magnification clanging operation of a subject image by moving the lens 1 in the direction of its optical axis is configured with the actuator 17 and the actuator driving circuit 18.

The external wired data I/F 22 is a connecting portion (interface) for performing transmission (sending and receiving) of image data and the like via a connection cable and the like, between the photographing apparatus 100 and an external apparatus (not shown). And the external wired data I/F 22 adopts a wired communication function in conformity with the USB (Universal Serial Bus) standard and the IEEE1394 standard or the like, for example. In the photographing apparatus 100, a system having a wired communication function in conformity with the USB standard is shown as an example.

The main part of wired communication means for establishing data communication by wired connection between the photographing apparatus 100 and an external apparatus (not shown) and transmitting an image file between the photographing apparatus 100 and the external apparatus is configured with the use of the external wired data I/F 22, a connection cable connected thereto (not shown), and wired communication control means (a wired communication control function section 31c described later and the like) provided in a system control section 31a of the first CPU 31.

The key matrix 23 is used as a generic name of operation inputting means including various operation switches, operation buttons and the like provided for the photographing apparatus 100.

That is, concrete operation members included in the key matrix 23 are inputting operation system members, such as a power source button for switching between on and off states of the power source of the photographing apparatus 100, a release button for starting a photographing operation, a zoom button (TW button) which functions as a zoom button for changing the photographing magnification when a photographing operation is performed and functions as a display switching button for performing enlarged or reduced display of a reproduced image when a reproducing operation is performed, multiple various operation buttons assigned to various functions such as a function of calling a menu screen, a four direction selection key (also referred to as a cross key) for performing selection and setting on the menu screen and the like, and an OK button for instructing determination of an item selected by the various operation buttons.

The key matrix 23 is configured by the multiple various operation members described above, switch members for generating a predetermined instruction signal respectively in conjunction with the operation members, electrical circuits for communicating an instruction signal from each of the switch members, and the like.

An instruction signal generated by a user operating each operation member of the key matrix 23 is outputted to the first CPU 31.

The LCD displaying circuit 24 is a circuit which controls the LCD panel 25 on the basis of control by the first CPU 31 and causes the LCD panel 25 to display various information.

The LCD panel 25 is configured, for example, by a small-sized liquid crystal display device (LCD) or the like, and the LCD panel 25 is an information display member which displays photographing conditions that has been set in the photographing apparatus 100 or various setting information, for example, operation mode information such as the photographing mode, information about the number of images which can be stored in the storage medium 16, shutter speed and information about exposure such as a diaphragm value, and the like.

The battery 26 is a main power source of the photographing apparatus 100.

The backup power source 28 is provided to continuously supply power to an internal memory, an internal clock and the like of the photographing apparatus 100. The backup power source 28 is a sub power source, for example, for holding information such as various set values, date and time information, and the like in the photographing apparatus 100, or for continuously enabling a time and date to be displayed with the use of LCD panel 25.

The power source circuit 27 is a circuit which, on the basis of an instruction from the first CPU 31 receives the power source from the battery 26 and the backup power source 28 and controls a supply to each electrical circuit inside the photographing apparatus 100 as appropriate.

The battery state detecting circuit 29 is a circuit which detects the state of the battery 26, such as the voltage of the battery 26, calculates the remaining battery life and the like of the battery 26, and outputs the result to the first CPU 31.

The first CPU 31 is arranged as a main CPU. The first CPU 31 is main control means for performing overall control of the circuits in the photographing apparatus 100 as well as controlling each component to realize multiple various functions.

Therefore, the first CPU 31 of the photographing apparatus 100 is provided with the system control section 31a for controlling the entire system by controlling each component in the photographing apparatus 100 as appropriate.

In the system control section 31a, there are formed various electrical circuits and the like. The system control section 31a is configured to have various control circuits for controlling various operations and various functions in the photographing apparatus 100 inside it, such as a wireless communication control function section 31b, the wired communication control function section 31c, an album displaying function section 31d, a printing function section 31e, a “not-deletable” flag setting function section 31f and a “transferred” flag setting function section 31g, and in addition, a circuit section as photographing condition setting means for setting various photographing conditions used when a photographing operation is executed by the photographing means, a circuit section as image file generation means for generating an image file with image data of an image signal acquired by a photographing operation and various information (related information data) related to the image data, a circuit section which controls a storing operation of storing the image file generated by the image file generation means into the storage medium 16 in an appropriate format, and a circuit section which executes a displaying operation of presenting an image and related information based on the image file in a visually displayable format with the use of the displaying means, and the like, though they are not shown in the figure.

The wireless communication control function section 31b is a circuit configured as wireless communication control means for controlling the function of data communication via wireless connection by performing on/off control of the external wireless data I/F 20 and the like which are a part of wireless communication means.

The wireless communication means in the photographing apparatus 100 performs wireless data communication for sending and receiving information (a data signal and the like) by establishing wireless connection with an external apparatus (not shown) provided with a wireless communication function.

As a method for realizing the wireless communication function in the photographing apparatus 100, for example, WUSB (Wireless Universal Serial Bus: WUSB) connection by a wireless communication function in conformity with the Wireless USB standard, ultra wide band (UWB) wireless connection, optical wireless connection by an infrared communication function in conformity with the IrDA (Infrared Data Association) standard, and the like are applicable.

Therefore, the photographing apparatus 100 has the wireless antenna 21, the external wireless data I/F 20, and the wireless communication means configured by the wireless communication control function section 31b and the like as the wireless communication control means provided in the system control section 31a of the first CPU 31.

The wireless antenna 21 is a wireless signal inputting/outputting section which, when wireless data communication is performed between the photographing apparatus 100 and an external apparatus (not shown), receives a wireless signal such as an electromagnetic wave in a predetermined form which is transmitted from the external apparatus and which is related to the data communication, and transmits a wireless signal such as an electromagnetic wave in a predetermined form which is a wireless signal for the data communication.

The wireless antenna 21 is connected to the external wireless data I/F 20, and transmitted and received wireless signals are inputted to and outputted from the first CPU 31 via the external wireless data I/F 20.

The external wireless data I/F 20 intervenes between the wireless antenna 21 and the first CPU 31. The external wireless data I/F 20 is a part of the wireless communication means for converting a wireless signal inputted to the wireless antenna 21 to an electrical signal in a predetermined form and outputting it to the first CPU 31 and for converting a signal from the wireless communication control function section 31b of the first CPU 31 into a wireless signal and outputting it to the wireless antenna 21, and the external wireless data I/F 20 functions as a wireless communication connecting section (interface).

The external wireless data I/F 20 is controlled by the wireless communication control function section 31b (wireless communication control means) of the system control section 31a of the first CPU 31.

On the other hand, the wired communication control function section 31c is a circuit configured as the wired communication control means for performing on/off control of the external wired data I/F 22 and the like, which is a part of the wired communication means, to control the function of data communication via a wired connection. The wired communication control function section 31c is electrically connected with the external wired data I/F 22.

Thus, in the photographing apparatus 100, wired or wireless connection between the photographing apparatus 100 and an external apparatus is secured by the control by the wired communication control function section 31c (wired communication means) or the wireless communication control function section 31b (wireless communication means), and thereby, an image file stored in the image information storing means (storage medium 16) of the photographing apparatus 100 can be transmitted to an external apparatus.

In this case, as for the image file transmitted via the data communication with the external apparatus, the wired communication control function section 31c (wired communication means) or the wireless communication control function section 31b gives a “transferred” flag which is a flag indicating that and which is transmission history information, a first mark and transmitted information, to a predetermined area in the header of the image file.

Thus, the wired communication control function section 31c and the wireless communication control function section 31b play the role of transmission means which is a transmitting section for transmitting an image file stored in the image information storing means (storage medium 16) to an external apparatus as well as playing the role of transmission history giving means which is a transmission history giving section for giving the transmission history information (first mark) to the image file transmitted to an external apparatus.

The album displaying function section 31d is a part of a circuit section which executes displaying operation processing for displaying an image based on an image file and related information which are stored in the storage medium 16 in a visually displayable format with a use of the displaying means. The album displaying function section 31d especially performs processing control when a displaying operation in an album display format is executed.

Here, the album displaying function means a function of collectively displaying image files selected and specified by a user from among image files stored in the storage medium 16, on the displaying section of a display device, and the like.

Specifically, the album displaying function includes a function of giving image files selected and specified from among multiple image files stored in the storage medium 16 by a user performing a predetermined operation, an album registration flag which is use specification information indicating that an image file is to be used by an application for the album displaying function and is a second mark, a function of reading image files having the album registration flag from among the multiple image files stored in the storage medium 16 and displaying images based on the image files continuously or in various display formats such as a list form with the use of the display device.

The printing function section 31e is a circuit section which executes processing control when printing of an image based on an image file stored in the storage medium 16 is performed.

Here, the printing function is a function of a user selecting and specifying an image file which he desires to print, from among the image files stored in the storage medium 16, and setting printing conditions or a function of collectively transmitting image files specified to be printed, to an image printing apparatus and causing the image printing apparatus to print them.

Specifically, the printing function includes a function which is processing to be performed for image files (one or multiple image files) selected and specified from among multiple image files stored in the storage medium 16 by the user performing a predetermined operation, and which is for giving the use specification information (a second mark, a printing reservations flag) indicating that an image file is to be used by an application for the printing function, to the image file, a printing condition setting function of setting desired printing conditions (various printing conditions, such as the number of prints, trimming instruction and synthesis image specification) for an appropriate image file in advance, a function of, in response to a printing starting operation by the user, sequentially reading image files having the use specification information (printing reservation flag or the like) from among the multiple image files stored in the storage medium 16 and transmitting the image files to an image printing apparatus which is an external apparatus, a function of causing printing of an image to be performed, in cooperation with a control section of the image printing apparatus.

As described above, the album displaying function section 31d and the printing function section 31e play the role of use-by-application specifying means which is an use-by-application specifying section which specifies that an image file stored in the image information storing means (storage medium 16) should be used by an application as well as playing the role of a use information giving section which gives the second mark to the image file specified to be used by an application.

Furthermore, when the user performs a predetermined operation of releasing album registration or printing reservation, the album displaying function section 31d or the printing function section 31e deletes the flag which is the use specification information set for an appropriate image file.

In this case, the album displaying function section 31d or the printing function section 31e functions as use-by-application specification releasing means which is a use-by-application specification releasing section which releases the image file from the state of being specified by the use specification information, that is, the use specification information (the second mark, the album registration flag, the printing reservation flag and the like) given to the image file.

The “not-deletable” flag setting function section 31f is a circuit section which performs processing control for automatically giving the header portion or the like of an image file specified by the album displaying function section 31d or the printing function section 31e (use-by-application specifying means) to be used by each function, a “not-deletable” flag for prohibiting deletion of the image file.

The “transferred” flag setting function section 31g is a circuit section which, when processing for transfer to an external apparatus is executed with the use of the wireless communication means or the wired communication means, and processing for causing an image file to be stored into the image storing means of the external apparatus is performed, performs processing control for giving the “transferred” flag to the image file in the storage medium 16 in the photographing apparatus 100.

Here, the outline of the file structure of an image file generated by the photographing apparatus 100 will be briefly described below.

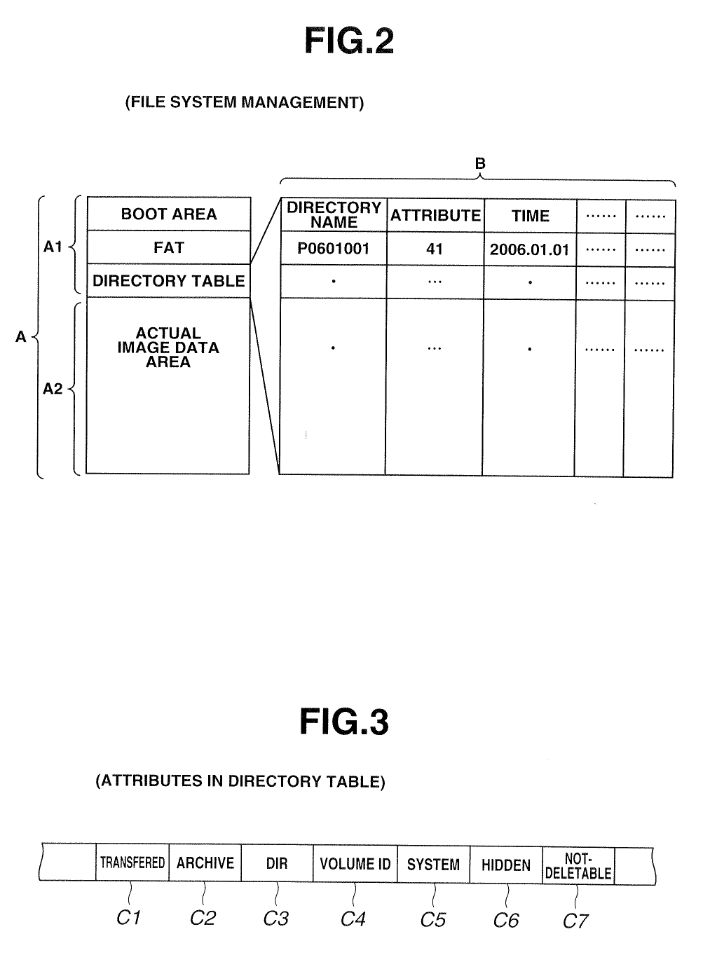

FIG. 2 is a diagram conceptually showing the file structure of an image file generated by the photographing apparatus, and FIG. 3 is a diagram conceptually showing the contents of a directory table in the header portion of the image file shown in FIG. 2.

As shown in FIG. 2, an image file A generated by the photographing apparatus 100 is configured by an actual image data area A2 where the substance of image data is stored, and a header area A1 including a boot area, FAT (File Allocation Table), and related information such as a directory table.

In the directory table in the header area A1, various information data related to the image file, such as the directory name, attribute and time of the image file, is stored as shown in columns denoted by a reference character B in FIG. 2.

Among these, attribute information stored in the directory table includes the “transferred” flag (C1 column), a compressed flag (C2 column; Archive), a directory flag (C3 column; Dir), a volume ID flag (C4 column; Volume ID), a system flag (C5 column; System), a hidden attribute (C6 column; Hidden), a “not-deletable” flag (C7 column) and the like, as shown in FIG. 3.

As described above, the photographing apparatus 100 has various functions for performing various kinds of processings of an image file stored in the storage medium 16. The functions are realized by application software (hereinafter referred to simply as applications) which are processing programs to be read from the EEPROM 19 and executed by the first CPU 31 or the second CPU 32 as appropriate.

In addition to the applications, for example, data such as communication setting information for communicating with an external apparatus (not shown), various setting data and apparatus-specific data of the photographing apparatus 100, and the like are stored in the EEPROM 19.

That is, the EEPROM 19 is a non-volatile storage medium for storing and holding the applications and the various data in advance. For example, Flash ROM or the like is applied.

As concrete examples of the applications stored in the EEPROM 19 in the photographing apparatus 100, the album displaying function and the printing function described above, which are applications for realizing a predetermined function with the use of an image file stored in the image information storing means (storage medium 16), are given.

In this case, the first CPU 31 and the second CPU 32 function as processing means which is a processing section for executing an application which uses an image file stored in the image information storing means (storage medium 16).

In the present embodiment, especially the two functions described above (the album displaying function and the printing function) will be described in detail as functions which can be performed by the photographing apparatus 100. Though description of other functions of the photographing apparatus 100 will be omitted, a processing control circuit section corresponding to each function is provided, and corresponding processing control is performed in each processing control circuit section, almost same as the two functions described above.

Thus, the first CPU 31 is an integrated circuit mainly for performing various operation controls.

On the other hand, the second CPU 32 is an integrated circuit mainly for performing various processing controls handling image data.

That is, the second CPU 32 is configured to include, in addition to various circuits for performing various signal processings on the basis of image data acquired form the photographing means or the image information storing means and temporarily stored in the frame memory 6, for example, an image compressing/expanding section 32a and a storage medium accessing section 32b and the like, various circuits for performing confirmation processing and the like about the internal state of the storage medium 16 and various files stored in the storage medium 16, via the storage medium accessing section 32b, for example, a storage medium data deleting function section 32c, a storage medium free capacity checking function section 32d, a deletion target data checking function section 32e and the like.

The image compressing/expanding section 32a is a circuit section which reads image data and the like stored in the frame memory 6 to perform, for example, JPEG compression processing thereof or performs expansion processing of compressed image data read from the storage medium 16.

The storage medium accessing section 32b is a circuit section for controlling access to the storage medium 16 by the storage medium I/F 15.

The storage medium free capacity checking function section 32d is a remaining-capacity-of-medium detecting section which accesses a predetermined area of the storage medium 16 via the storage medium accessing section 32b, checks the whole storage space capacity and the used storage capacity of the storage medium 16 (image information storing means) to check and detect free storage capacity of the storage medium 16, and which plays the role of remaining-capacity-of-medium confirming means.

The deletion target data checking function section 32e is a circuit section which accesses a predetermined area of the storage medium 16 via the storage medium accessing section 32b and searches the header portions of image files stored in the storage medium 16 (image information storing means) to confirm and extract an image file to be deleted, that is, an image file having transmitted information (the “transferred” flag) given by the transmission history giving means (the wireless communication control function section 31b or the wired communication control function section 31c) and which checks whether or not the image file is given the use specification information (second mark) such as the album registration flag and the printing reservation flag.

The storage medium data deleting function section 32c is a circuit section which is a deletion specifying section for specifying the image file extracted by the deletion target data checking function section 32e described above, that is, an image file having the transmitted information (the first mark, the transmission history information) given by the transmission history giving means, as a deletion target when it is confirmed by the storage medium free capacity checking function section 32d described above that the free storage capacity of the storage medium 16 is a predetermined amount or less, and more specifically, that the free storage capacity is, for example, 20% (the numerical value is only an example) or less of the whole storage capacity, and which also plays the role of deletion means which is a deleting section for deleting the image file as well as playing the role of deletion control means which is a deletion control section for, when the use specification information (the second mark, the album registration flag or the printing reservation flag) is given by the deletion target data checking function section 32e described above, prohibiting deletion of the image file.

Furthermore, the storage medium data deleting function section 32c as the deletion means is adapted to delete an image file only when the use specification information (the album registration flag, the printing reservation flag or the like) is released by the album displaying function section 31d or the printing function section 31e as the use-by-application specification releasing means, and the “transferred” flag exists. That is, if the “transferred” flag corresponding to an image file exists, then processing control is performed to prohibit deletion so that the image file should not be handled as a deletion target, even if the use specification information is released.

The configurations of other parts which are not related to the present invention are assumed to be similar to those of an ordinary digital camera, and detailed illustration and description thereof will be omitted.

Next, the operation of the photographing apparatus 100 configured as described above will be described below.

First, photographing operation processing and image storage processing in the photographing apparatus 100 are performed as follows.

That is, when a user operates the power source button in the key matrix 23, the photographing apparatus 100 is activated (powered on). Generally, the operation mode when the photographing apparatus 100 is activated is the photographing mode.

By the user performing a predetermined series of operations such as a releasing operation when the photographing apparatus 100 is activated in the photographing mode, the photographing apparatus 100 executes the photographing operation processing.

Specifically, in a state that the photographing apparatus 100 is activated in the photographing mode, the user first performs driving control of the lens driving means (the actuator 17 and the actuator driving circuit 18) by operating the zoom button and performs a magnification changing operation (zooming operation) for setting a desired composition.

Specifically, an instruction signal for starting execution of the magnification changing operation processing is generated from the key matrix 23 by operating the zoom button, and the instruction signal is communicated to the first CPU 31. In response to this, the first CPU 31 performs driving control of the actuator 17 via the actuator driving circuit 18. Thereby, the lens 1 is driven, and the magnification changing operation is executed.

By operating the first stage of the release button, the user performs driving control of the lens driving means, the image pickup circuit 3 and the image pickup device 2 to execute an autofocus adjusting operation (AF operation), an autoexposure operation (AE operation) and the like.

Specifically, an instruction signal for starting execution of autofocus adjusting operation processing, and autoexposure operation processing is generated from the key matrix 23 by operating the first stage of the release button, and the instruction signal is communicated to the first CPU 31. In response to this, the first CPU 31 performs driving control of the image pickup device 2 and the image pickup circuit 3 and performs driving control of the actuator 17 via the actuator driving circuit 18 to drive the lens 1. Thereby, the autofocus adjusting operation and the autoexposure operation are executed.

Next, in response to an operation of the second stage of the release button by the user, the first CPU 31 performs driving control of the photographing means to execute the photographing operation processing.

Specifically, an instruction signal for starting execution of the photographing operation processing is generated from the key matrix 23 by operating the second stage of the release button, and the instruction signal is communicated to the first CPU 31. In response to this, the first CPU 31 controls the photographing means such as the image pickup device 2 and the image pickup circuit 3 to execute the photographing operation processing. Thereby, image data indicating a desired image and related information which is related to the image data are acquired, and an image file in which both data are combined is generated.

The image file generated in this way is stored in a predetermined storage area of the storage medium 16 in a predetermined format by the first CPU 31 controlling the second CPU 32, the image information storing means and the like.

The photographing operation processing and the image storage processing in the photographing apparatus 100 as described above is almost same as the operation processings in a conventional ordinary digital camera.

On the basis of the image file acquired and stored in the storage medium 16 as described above, the photographing apparatus 100 can perform various functions, for example, a display processing function of displaying an image and its related information in various formats with the use of the displaying means, a communication function of performing processing for transferring the image file to an external apparatus with the use of the communication means, an image processing and printing condition setting function of printing, a printing processing function of transferring the image file to a printing apparatus as an external apparatus to execute printing, and the like.

In this case, in order to execute the various functions, the user selects and specifies a desired target image file and performs an operation of enabling the selected and specified image file to be used by an application corresponding to each function so that the desired image file can be handled by desired functions. By performing the selecting/specifying operation, the second mark is given to the header portion of the desired image file.

Specifically, for example, in the case of executing the album displaying function among the display processing functions, the album registration flag as the second mark is given to the target image file by performing an album registering, operation of selecting and specifying an image file to be used by the application for the album displaying function.

Furthermore, for example, in the case of executing the printing function, the printing reservation flag as the second mark is given to a target image file by performing a printing reserving operation of selecting and specifying an image file to be used by the application for the printing function.

In addition to the selecting/specifying operation of an image file to be printed, the printing reserving operation may also include an operation of setting various printing conditions such as the number of prints and the trimming position of an image based on the selected and specified image file.

Among the operations of executing the various functions which can be performed in the photographing apparatus 100, the album registering operation and the printing reserving operation described above are performed as described below.

First, when the photographing apparatus 100 is activated in the reproduction mode, the first CPU 31 controls the second CPU 32 and the image information storing means to read an image file stored in the storage medium 16 into the frame memory 6, and controls the displaying means (such as the TFT panel 10) to execute image display processing for displaying an image based on the selected and specified image file on the display screen. In this case, characters or an icon indicating information related to the image may be overlappedly displayed on the image displayed on the display screen.

The image display processing includes, for example, one-frame display format display processing for displaying an image based on one image file with the use of the whole display screen of the TFT panel 10 which is the displaying means, list display format display processing for displaying reduced images (thumbnail images) based on image files arranged, in divided areas obtained by the user arbitrarily operating the zoom button and the like during display in the one-frame display format to equally divide the whole display screen of the TFT panel 10 (for example, into four, nine or sixteen), and the like.

When the photographing apparatus 100 is operating in the reproduction mode, the user performs an operation of selecting and specifying a desired image, referring to the images being displayed, by operating the cross key, the OK button and others in the key matrix 23.

That is, an operation of selecting and specifying a particular image file among image files stored in the storage medium 16 to be used with a desired function (application).

By such an operation being performed, the first CPU 31 receives a selection/specification signal from the key matrix 23 and controls the album displaying function section 31d and the printing function section 31e to execute control processing for giving a corresponding flag, that is, the album registration or the printing reservation flag, to the header portion of the image file, as a part of related information about the image file.

In this case, the album registration flag, the printing reservation flag and the like are stored, for example, in a predetermined area in the attributes in the directory table shown in FIG. 3.

At the same time, the first CPU 31 controls the “not-deletable” flag setting function section 31f to execute the deletion prohibition registration processing which is control processing for giving the “not-deletable” flag to the header portion of the image file as a part of related information.

It is also possible to release album registration or printing reservation by performing an operation almost same as the album registering operation or the printing reserving operation described above.

When the releasing operation is performed, the first CPU 31 controls the “not-deletable” flag setting function section 31f to execute deletion prohibition release processing which is control processing for deleting (clearing) the “not-deletable” flag from the header portion of the image file.

The condition of the “not-deletable” flag described above being given to an image file is that at least one of the flags corresponding to each of the functions, such as the album registration flag and the printing reservation flag, is given as the related information about the image file.

The condition of the “not-deletable” flag described above being deleted from an image file is that any of the flags corresponding to each of the functions, such as the album registration flag and the printing reservation flag, is not given as the related information about the image file, but is released.

Here, the sequence of the deletion prohibition registration processing in the photographing apparatus 100 will be described below.

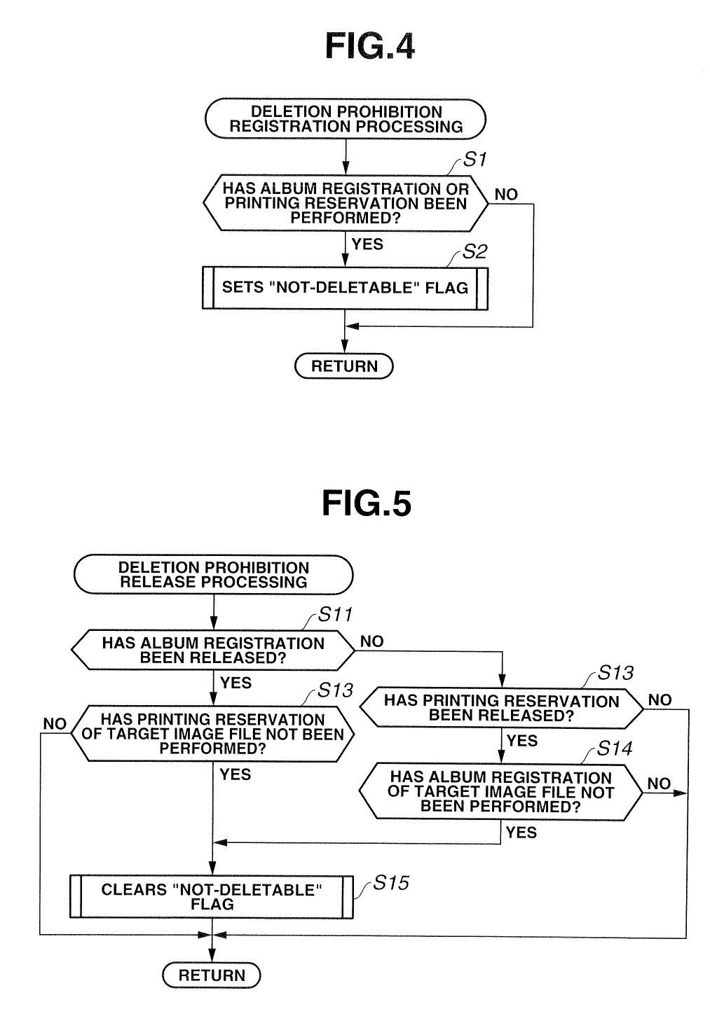

FIG. 4 is a flowchart showing the flow of the deletion prohibition registration processing in the photographing apparatus including the image storage device of the present embodiment.

In the photographing apparatus 100, the time (timing) when the deletion prohibition registration processing is to be executed is the time point when the operation of selecting and specifying a particular image file, among the image files stored in the storage medium 16, to be used by a desired function (application) is performed, as described above.

That is, when the photographing apparatus 100 is activated in the reproduction mode, the user executes the album displaying function or the printing function. While any of the applications of the various functions is executed, the processing for performing a selecting/specifying operation of a desired image file is performed as described above. Then, when the selecting/specifying operation is executed, the flow branches to a processing sequence as shown in FIG. 4.

Then, at step S1 in FIG. 4, the first CPU 31 checks whether or not use by an application has been selected and specified, that is, specifically, whether or not the album registration or the printing reservation has been performed. If an album registration or printing reservation instruction signal is not confirmed, the first CPU 31 ends the processing sequence without doing anything and returns to the original processing sequence (return).

If an album registration or printing reservation instruction signal is confirmed, the first CPU 31 proceeds to the processing of a next step S2.

At step S2, the first CPU 31 executes processing for setting the “not-deletable” flag for the header portion of the image file. After that, the first CPU 31 ends the processing sequence and returns to the original processing sequence (return).

In this way, as for the “not-deletable” flag given to the header portion of an image file, when a predetermined operation is performed by the user while any of the applications of the various functions is executed, the deletion prohibition release processing for clearing the “not-deletable” flag is performed as appropriate.

Here, the sequence of the deletion prohibition release processing in the photographing apparatus 100 will be described below.

FIG. 5 is a flowchart showing the flow of the deletion prohibition release processing in the photographing apparatus including the image storage device of the present embodiment.

In the photographing apparatus, the time (timing) when the deletion prohibition release processing is to be executed is the time point when, for an image file specified to be used by a desired application among the image files stored in the storage medium 16, a specification releasing operation which is a predetermined operation of releasing the use specification is performed.

That is, when the photographing apparatus 100 is activated in the reproduction mode, processing for performing an operation of releasing selection/specification of a desired image file is performed during execution of an application such as the album displaying function and the printing function. Then, when the selection/specification releasing operation is executed the flow branches into a processing sequence as shown in FIG. 5.

Then, at step S11 in FIG. 5, the first CPU 31 checks whether or not the operation of releasing the album registration, among specifications of use by application, has been performed. Here, if an album registration release instruction signal is confirmed, the first CPU 31 proceeds to processing at a next step S13.

At step S13, the first CPU 31 checks the header portion of an image file targeted by the album registration release instruction signal in the processing at step S11 to check whether printing reservation of the image file is not performed, that is, whether the printing reservation flag is not given to the image file. Here, if it is confirmed that the printing reservation flag is not given, the first CPU 31 proceeds to processing at a next step S15.

At step S15, the first CPU 31 executes processing for clearing (deleting) the “not-deletable” flag of the header portion of the image file. After that, the first CPU 31 ends the processing sequence and returns to the original processing sequence (return).

On the other hand, if the album registration release instruction signal is not confirmed at step S11 described above, then the first CPU 31 proceeds to processing at step S12.

At step S12, the first CPU 31 checks whether or not an operation of releasing the printing reservation, among specifications of use by an application, has been performed. Here, if a printing reservation release instruction signal is confirmed, the first CPU 31 proceeds to processing at a next step S14.

At step S14, the first CPU 31 checks whether album registration of an image file targeted by the printing reservation release instruction signal in the processing at step S12 has not been performed, that is, whether the album registration flag is not given to the image file. If it is confirmed that the album registration flag is not given, the first CPU 31 proceeds to processing at step S15. At step S15, after executing processing for clearing (deleting) the “not-deletable” flag of the header portion of the image file similarly, the first CPU 31 ends the processing sequence and returns to the original processing sequence (return).

In any of the cases where it is confirmed at step S13 described above that the printing reservation flag is given, the case where the printing reservation release instruction signal is not confirmed at step S12 described above, and the case where it is confirmed at step S14 described above that the album registration flag is given, the first CPU 31 ends the processing sequence without doing anything and returns to the original processing sequence (return).

As described above, the user acquires an image file by causing the photographing apparatus 100 to operate in the photographing mode, and, with image files stored in the storage medium 16 as a target, performs an operation of selecting and specifying an image file to be used by a desired function (application) or a setting operation for the file, or executes a selection/specification releasing operation and the like in a state that the photographing apparatus 100 is operating in the reproduction mode. Thereby, flags corresponding to various functions are given to the header portion of a predetermined image file.

In the photographing apparatus 100, it is possible to, by performing processing for transferring an image file stored in the storage medium 16 to an external apparatus such as a different image storage device, to transfer the desired image file to an image storage device (storage medium) of the external apparatus.

Here, the sequence of the image file transfer processing in the photographing apparatus 100 will be described below.

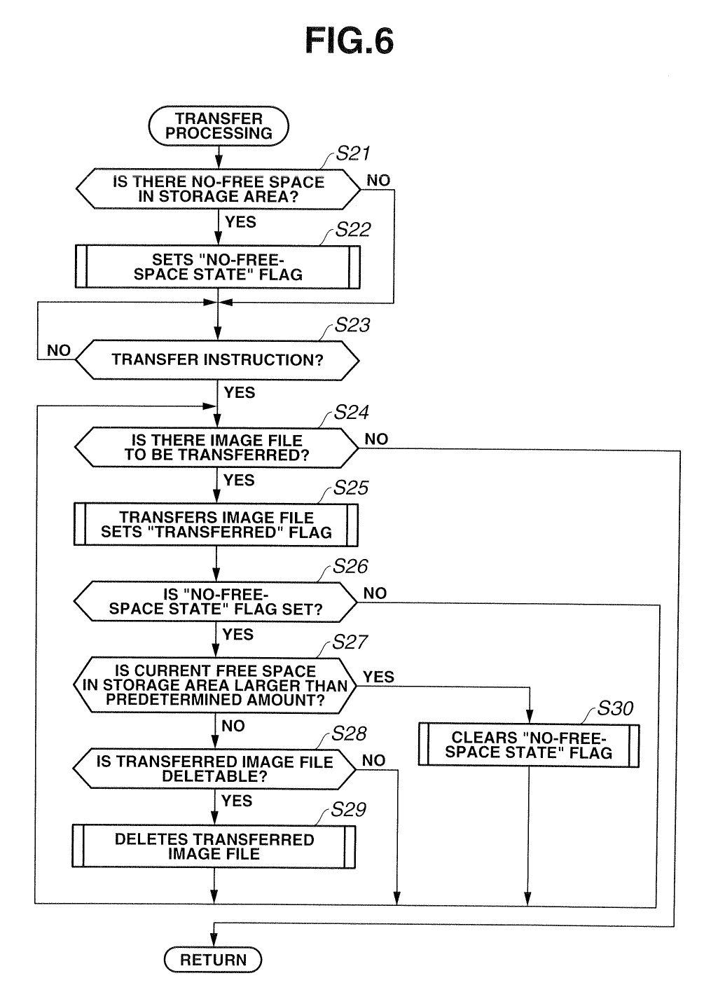

FIG. 6 is a flowchart showing the flow of the image file transfer processing in the photographing apparatus including the image storage device of the present embodiment.

When a user performs a predetermined operation to switch to an image file transfer mode when the photographing apparatus 100 is activated in the reproduction mode, the first CPU 31 executes transfer processing for executing processing for transferring an image file to an external apparatus, with the use of the wireless communication means or the wired communication means.

In this case, the user first selects and sets which of the wireless communication means or the wired communication means is to be used to execute the transfer processing. In response to this, the first CPU 31 performs initialization processing so that the selected and set communication means can effectively function.

Then, at step S21 in FIG. 6, the first CPU 31 controls the storage medium free capacity checking function section 32d to check whether there is no-free space in the storage area of the storage medium 16. If it is confirmed that there is not a predetermined free space, the first CPU 31 proceeds to processing at a next step S22. In this case, if the free storage capacity is, for example, 20% (the numerical value is only an example) or less of the whole storage capacity of the storage medium 16, then the first CPU 31 judges that there is no-free space.

At step S22, the first CPU 31 executes processing for setting a no-free-space state flag. After that, the first CPU 31 proceeds to processing at step S23.

On the other hand, if it is confirmed by the processing at step S21 described above that there is enough free space, the first CPU 31 immediately proceeds to processing at step S23.

At step S23, the first CPU 31 enters a waiting state for monitoring an image file transfer instruction signal. The transfer instruction signal is generated by a predetermined operation of the key matrix 23 performed by the user. When the transfer instruction signal is confirmed, the first CPU 31 proceeds to processing at a next step S24.

At step S24, the first CPU 31 searches the header portions of image files stored in the storage medium 16 to check whether or not there is an image file to be transferred to an external apparatus, that is, a transfer target image file.

Here, the transfer target image file is, for example, an image file selected and specified by a predetermined operation by the user, which is an image file targeted by the transfer processing.

For example, when the photographing apparatus 100 is in the waiting state during the processing at step S23 described above being performed, the user gives an instruction to select an image file to be targeted by the transfer processing from among reduced images based on an image files displayed on the display screen of the displaying means by a predetermined operation. In this way, the image file instructed to be selected is made to be a transfer target image file, and at the same time, a transfer instruction signal is generated in response to the selection instructing operation described above. In the processing at, step S23 described above, the first CPU 31 starts an actual transferring operation in response to the transfer instruction signal.

The transfer target image file may be selected in advance by the user performing a predetermined operation. In this case, a transfer reservation flag may be given to the header portion or the like of a selected image file when the transfer target image file selection instructing operation is performed. In the processing at step S24 described above, an image file which is given the transfer reservation flag corresponds to the transfer target image file.

If it is confirmed by the processing al step S24 that the transfer target image file exists, then the first CPU 31 proceeds to processing at step S25. If it is confirmed here that the transfer target image file does not exist, then the first CPU 31 ends the transfer processing sequence and returns to the original processing sequence (return).

Next, at step S25, the first CPU 31 executes processing for actually transferring an image file corresponding to the transfer instruction signal in the processing at step S23 described above. With the use of the communication means. Though detailed description of the processing will be omitted, it is assumed that processing similar to that performed in an ordinary photographing apparatus and the like is performed. When the processing is completed, the first CPU 31 controls the “transferred” flag setting function section 31g to execute processing for giving (setting) the “transferred” flag into a predetermined area of the header portion of the image file transferred by the completed processing step. After that, the first CPU 31 proceeds to processing at step S26.

At step S26, the first CPU 31 checks is whether or not the no-free-space state flag is set. If it is confirmed here that the no-free-space state flag is set, the first CPU 31 proceeds to processing at step S27. If it is confirmed that the no-free-space state flag is not set, then the first CPU 31 returns to the processing at step S24 described above and repeats the subsequent processing.

At step S27, the first CPU 31 checks whether or not the current free capacity of the storage area in the storage medium 16 is larger than a predetermined amount (for example, 20% of the whole amount of the storage area of the storage medium 16). If it is confirmed that the free capacity is larger than the predetermined amount, the first CPU 31 proceeds to processing at step S30.

At step S30, the first CPU 31 executes processing for clearing the no-free-space state flag. After that, the first CPU 31 returns to the processing at step S24 described above and repeats the subsequent processing.

On the other hand, if it is confirmed by the processing at step S27 that the current free capacity of the storage area is smaller than the predetermined amount, the first CPU 31 proceeds to a next step S28.

At step S28, the first CPU 31 checks whether or not the transferred image file is deletable. The checking on whether deletable or not performed here is checking by the deletion target data checking function section 32e of the second CPU 32 controlled by the first CPU 31 on whether or not the “not-deletable” flag exists at the header portion of the transferred image file.

If it is confirmed here that the “not-deletable” flag is given to the transferred image file, and the image file is not deletable, then the first CPU 31 returns to the processing at step S24 described above and repeats the subsequent processing. On the other hand, if it is confirmed here that the “not-deletable” flag is not given to the transferred image file, and the image file is deletable, then the first CPU 31 proceeds to processing at step S29.

At step 29, the first CPU 31 controls the component members of the image storing means, such as the storage medium I/F 15 and the storage medium 16, via the storage medium data deleting function section 32c of the second CPU 32 to execute processing for deleting the target image file. After that, the first CPU 31 returns to the processing at step S24 described above and repeats the subsequent processing.

As described above, according to the first embodiment, by, when an image file stored in the storage medium 16 is used by any of applications for various functions, performing registration of use by the application or reservation setting therefor in the photographing apparatus 100 including the image storage device, information on specification of the use by the application (second mark), for example, specifically the album registration flag or the printing reservation flag is given to the header portion of the image file. The use specification information is given to the header portion of a target image file, or the given state is released in response to an operation by a user as appropriate. Then, when the use specification information is given to the image file, a mark indicating that deletion of the image file is prohibited (the “not-deletable” flag) is given at the same time.

On the other hand, in the photographing apparatus 100, when an image file stored in the storage medium 16 is transferred to an external apparatus and stored in a storage medium or the like of the transfer destination external apparatus, the transmission history information (the first mark, the transmitted information) is given to the header or the like of the image file, that is, the transferred image file.

During the image file transfer processing being executed, the photographing apparatus 100 checks, for transferred image files to which the transmission history information is given, whether or not the “not-deletable” flag is given, and deletes only image files to which the “not-deletable” flag is not given.

That is, in the case of an image file specified to be used by applications for various functions, that is, an image file to which the use specification information (second mark), for example, the album registration flag or the printing reservation flag is given, the “not-deletable” flag is given to prohibit deletion of the image file even if the image file is an image file already transferred to an external apparatus among image files stored in the storage medium 16 of the photographing apparatus 100.

Thus, according to the above, it is possible to prevent an image file which a user wants to use by the various functions of the photographing apparatus 100 from being deleted by the transfer processing, and thereby, it is possible to execute utilization of the image file by the various functions of the photographing apparatus 100 without trouble.

Furthermore, when a deletable image file, among transferred image files, is deleted from the storage medium 16 of the photographing apparatus 100, the free capacity of the storage medium 16 of the photographing apparatus 100 is checked, and the deletion processing is executed only when the free capacity is smaller than a predetermined amount. Therefore, a user can continue photographing operations without caring about the free capacity of the storage medium 16 in the photographing apparatus 100 and efficiently utilize image files stored in the storage medium 16 by various functions.

In the first embodiment described above, when a deletable image file among transferred image files is deleted, an actual transferring operation is performed during processing for transferring an image file to an external apparatus being performed, and it is checked whether or not the image file is deletable each time the transferring operation is performed. Then, if the image file is deletable as the result of the checking, the image file deletion processing is executed.

However, the timing of deleting a deletable image file is not limited to the example described above. In a second embodiment of the present invention described next shows an example in which the deletion timing differs.

That is, the second embodiment of the present invention shows an example in which the deleting operation is executed at a predetermined timing during processing of the photographing operation as the timing of deleting a deletable image file.

An image storage device of the present embodiment is included in a photographing apparatus having photographing means for photographing a subject, acquiring an image signal and generating an image file, similarly to the first embodiment described above. The basic configuration of the photographing apparatus is similar to that in the first embodiment described above. Therefore, to grasp the configuration of the photographing apparatus including the image storage device of the present embodiment, FIG. 1 is to be referred to, and the same reference numerals will be used in the description below.

In the present embodiment, when the amount of free space of a storage medium 16 is small during processing of the photographing operation of a photographing apparatus 100, it is checked whether or not there is an image file which has been transferred and is deletable. If there is such a deletable image file, the operation of deleting the image file is executed to secure free space of the storage medium 16, in order to make it possible to execute an operation of storing an image file newly acquired by the photographing operation.

In the photographing apparatus 100, processing for adding flags corresponding to various functions, for example, processing for adding an album registration flag, a printing reservation flag or the like is similar to that in the first embodiment described above.

Deletion prohibition registration processing and deletion prohibition release processing in the photographing apparatus 100 are also similar to those in the first embodiment described above (see FIGS. 4 and 5).

The file structure of an image file generated in the photographing apparatus 100 is also similar to that in the first embodiment described above (see FIGS. 2 and 3).

The processing sequence of image file transfer processing in the photographing apparatus 100 will be described below.

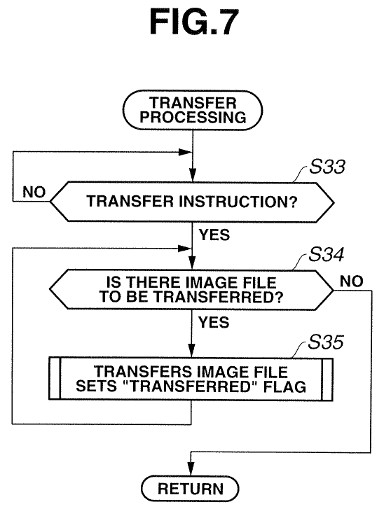

FIG. 7 is a flowchart showing the flow of the image file transfer processing in the photographing apparatus including the image storage device of the present embodiment.

When the mode is switched to an image file transfer mode by a predetermined operation by a user when the photographing apparatus 100 is activated in a reproduction mode, execution of the image file transfer processing is started. The image file transfer processing, that is, a series of processings from step S33 to step S35 in FIG. 7 is similar to the series of processings from step S23 to S25 (see FIG. 6) in the image file transfer processing sequence in the first embodiment described above.

At step S33 in FIG. 7, a first CPU 31 enters a waiting state for monitoring an image file transfer instruction signal. If the transfer instruction signal is confirmed here, the first CPU 31 proceeds to processing at a next step S34.

At step S34, the first CPU 31 searches the header portions of image files stored in the storage medium 16 to check whether or not a transfer target image file exists. If it is confirmed here that a transfer target image file exists, the first CPU 31 proceeds to processing at step S35. If it is confirmed here that a transfer target image file does not exist, the first CPU 31 ends the processing sequence of transfer processing (return).

Next, at step S35, the first CPU 31 executes processing for actually transferring the image file to be transferred with the use of communication means. When the processing is completed, the first CPU 31 controls a “transferred” flag setting function section 31g to execute processing for giving (setting) a “transferred” flag to a predetermined area of the header portion of the image file transferred by the completed processing step. After that, the first CPU 31 returns to the processing at step S34 and repeats the subsequent processing.

Next, the processing sequence of a photographing operation in the photographing apparatus 100 will be described below.

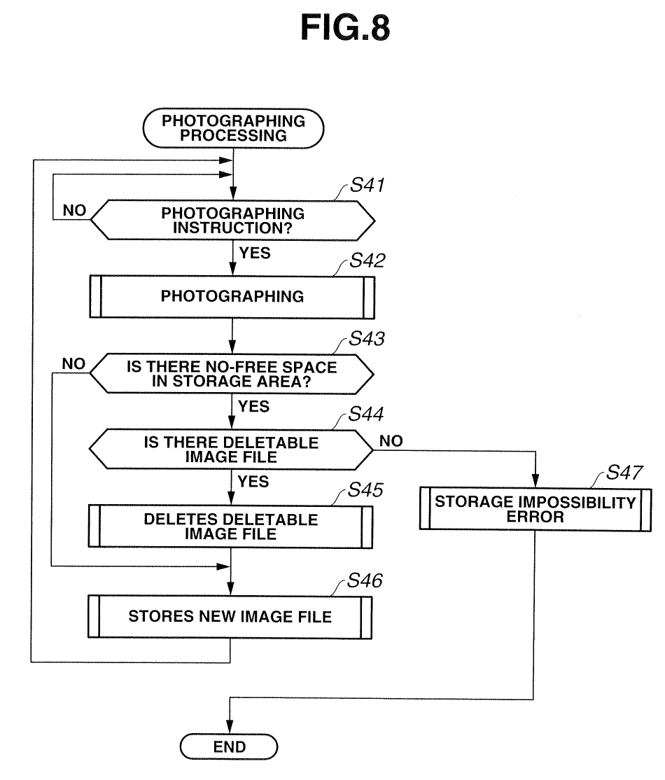

FIG. 8 is a flowchart showing the flow of photographing operation processing in the photographing apparatus including the image storage device of the present embodiment.

In a state that the photographing apparatus 100 is activated in the photographing mode, the first CPU 31 is waiting for a photographing instruction signal at step S41 in FIG. 8. The photographing instruction signal is an instruction signal generated by the user performing a predetermined series of operations such as a releasing operation. When a photographing instruction is confirmed, the first CPU 31 proceeds to processing at a next step S42.

At step S42, the first CPU 31 performs driving control of the photographing means to execute a series of processing operations for photographing a subject. Image data generated thereby and related information that is related to the image data are temporarily stored in a frame memory 6. When the series of operations up to acquisition of the image data and the like is completed, the first CPU 31 then proceeds to processing at step S43.

At step S43, the first CPU 31 controls a storage medium free capacity checking function section 32d to check whether there is no-free space in the storage area of the storage medium 16. If it is confirmed that there is enough free space, the first CPU 31 immediately proceeds to processing at step S46.

On the other hand, if it is confirmed at step S43 described above that a predetermined amount of free space does not exist, the first CPU 31 proceeds to processing at a next step S44.

At step S44, the first CPU 31 searches the header portions of the image files stored in the storage medium 16 to check whether or not there is a deletable image file, that is, an image file to which the “transferred” flag is given but a registration flag or a reservation flag given by various functions is not given and to which a “not-deletable” flag is not given. If it is confirmed here that there is not such a deletable image file, the first CPU 31 proceeds to processing at step S47.

Then, at step S47, the first CPU 31 executes storage impossibility error processing. The storage impossibility error processing is, for example, processing for displaying a warning to the effect that storage processing of an image file newly acquired cannot be executed due to a lack of free capacity of the storage medium 16. After that, the first CPU 31 ends the sequence of the series of processings. In this case, the warning is displayed until the error is released by a predetermined operation or until the power is turned off.

On the other hand, if it is confirmed by the processing at step S44 described above that there is a deletable image file, the first CPU 31 proceeds to processing at a next step S45.

At step S45, the first CPU 31 executes processing for deleting the deletable image file and updates a deletable image file list. After that, the first CPU 31 proceeds to processing at step S46.

At step S46, the first CPU 31 executes new image file storing operation processing. That is, processing for generating an image file on the basis of the image data acquired by the processing at step S42 described above and the related information related to the image data which are temporarily stored in the frame memory 6, and storing the image file into the storage area of the storage medium 16. After that, the first CPU 31 returns to the processing at step S41 described above and repeats the subsequent processing.

As described above, according to the second embodiment, free space of the storage medium 16 is checked during execution of the photographing operation processing. If it is confirmed that there is no-free space, deletion processing of a deletable image file is performed to secure free space of the storage medium 16 before storing a new image file. The advantages similar to those of the first embodiment described above can be also obtained by such a configuration.

In the first and second embodiments described above, free space of the storage medium 16 is checked when the transfer processing or the photographing operation processing is performed, and, if it is confirmed that there is no-free space, processing for automatically deleting a deletable image file is performed to secure free space of the storage medium.

In this case, the deletable image file is an image file which has already transferred to an external apparatus and for which use by applications for various functions is not specified.

On the other hand, there may be a case where there is an image file which a user desires to leave in the storage area of the storage medium 16 without deleting it from the storage medium 16 though the image file meets the conditions as a deletable image file in each of the embodiments described above, among the image files stored in the storage medium 16 of the photographing apparatus 100.

To cope with such a case, processing means is conceivable which is for inserting a processing step of a user performing a deletion permission/prohibition instructing operation when deletion processing of a deletable image file is performed. An example in consideration of this is will be described below by a third embodiment of the present invention shown next.

An image storage device of the present embodiment is included in a photographing apparatus having photographing means for photographing a subject, acquiring an image signal and generating an image file, similarly to the first embodiment described above. The basic configuration of the photographing apparatus is similar to that in the first embodiment described above. Therefore, to grasp the configuration of the photographing apparatus including the image storage device of the present embodiment, FIG. 1 is to be referred to, and the same reference numerals will be used in the description below.

In the photographing apparatus 100, processing for adding flags corresponding to various functions, for example, processing for adding an album registration flag, a printing reservation flag or the like is similar to that in the first embodiment described above.

Deletion prohibition registration processing and deletion prohibition release processing in the photographing apparatus 100 arc also similar to those in the first embodiment described above (see FIGS. 4 and 5).

The file structure of an image file generated in the photographing apparatus 100 is also similar to that in the first embodiment described above (see FIGS. 2 and 3).

The processing sequence of image file transfer processing in the photographing apparatus 100 will be described below.

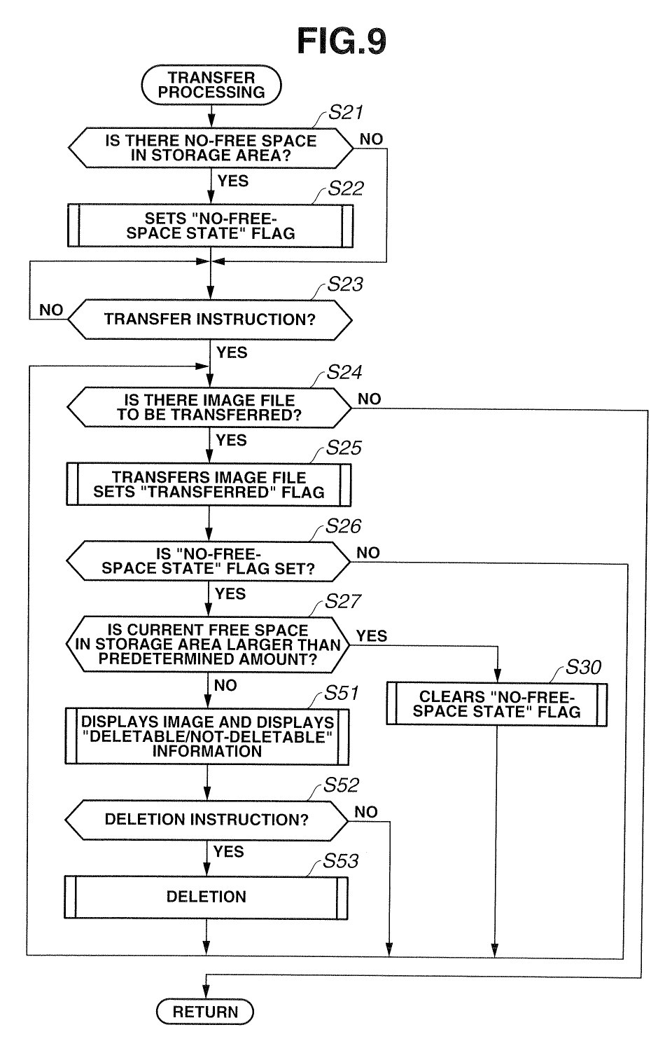

FIG. 9 is a flowchart showing the flow of the image file transfer processing in the photographing apparatus including the image storage device of the present embodiment.

The image file transfer processing in the photographing apparatus 100 is almost same as that in the first embodiment described above (see FIG. 6). Therefore, the same processing steps are given the same step numbers, and detailed description thereof will be omitted. Only different processing steps will be described below.

The processing from step S21 to step S27 is quite the same as that in the first embodiment described above.

At step S27, a first CPU 31 checks whether or not the current free capacity of the storage area in a storage medium 16 is larger than a predetermined amount. If it is confirmed that the free capacity is larger than the predetermined amount, the first CPU 31 proceeds to processing at step S30, similarly to the first embodiment (FIG. 6) described above. At step S30, the first CPU 31 executes processing for clearing a no-free-space state flag. After that, the first CPU 31 returns to the processing at step S24 described above and repeats the subsequent processing.

On the other hand, if it is confirmed by the processing at step S27 that the current free capacity of the storage area is smaller than the predetermined amount, the first CPU 31 proceeds to processing at a next step S51.

At step S51, the first CPU 31 controls displaying means to display an image based on an image file transferred immediately before, and especially “deletable”, information or “not-deletable” information among information related to the image file, on the display screen of a TFT panel 10. After that, the first CPU 31 proceeds to processing at step S52.

The information indicating that deletion is enabled or disabled displayed here is information obtained by a deletion target data checking function section 32e of a second CPU 32 controlled by the first CPU 31 checking whether or not a “not-deletable” flag exists at the header portion of the transferred image file. At step S52, the photographing apparatus 100 enters a waiting state for a deletion instruction signal. Here, the first CPU 31 monitors an instruction signal from a key matrix 23.

Then, when a deletion instruction signal to the effect that an image file corresponding to the image displayed on the TFT panel 10 (that is, the transferred image file) should be deleted is generated by a user performing a predetermined operation, the first CPU 31 proceeds to processing at a next step S53.

At step S53, the first CPU 31 controls a storage medium data deleting function section 32c (deleting means) of the second CPU 32 to execute deletion processing of the specified image file (the image file which is currently displayed and which has already been transferred). That is, the storage medium data deleting function section 32c (deletion means) deletes an image file (transferred image file) identified by an attribute list file including the “transferred,” flag (first identification information) which is stored in the storage medium 16 (image information storing means). After that, the first CPU 31 returns to the processing at step S24 described above and repeats the subsequent processing.

On the other hand, if the deletion instruction signal is not generated because the predetermined operation by the user is not performed within a predetermined time, or if a signal of an instruction to cancel deletion by the user is confirmed, during the processing at step S52 described above, the first CPU 31 returns to the processing at step S24 described above without performing the deletion processing, and repeats the subsequent processing.

As described above, according to the third embodiment, the advantages similar to those of the first embodiment described above can be obtained. Furthermore, since a user specifies, during execution of transfer processing, whether or not to delete a transferred file each time, even an image file which meets conditions of enabling deletion is not automatically deleted, and it is possible to store a desired image file in the image storage device of the photographing apparatus 100.

In each of the embodiments described above, the transmission history information (the first mark; the “transferred” flag) indicating that an image file is a transferred image file, the use specification information specifying use by applications for various functions (the second mark, the album registration flag, the printing reservation flag and the like), the accompanying “not-deletable” flag and the like are given to a predetermined area of the header portion of the image file.

By giving individual information corresponding to each image file as described above, related information specific to each image file always accompanies the image file even if the image file is moved. This is advantageous in that corresponding related information is always retained and is never lost. On the other hand, in the case of searching the related information, it is necessary to search the headers of all the image files stored in the storage medium 16.

Accordingly, in consideration of searching related information of each image file, means for creating an attribute list data file (hereinafter referred to as an attribute list file) which shows correspondence between related information to be searched and management information (attribute information) about image files stored in a storage medium and managing the file as a file different from the image files is conceivable. An example of the case in which the means is taken into account will be described below by a fourth embodiment of the present invention shown next.

An image storage device of the present embodiment is included in a photographing apparatus configured similarly to that in each of the embodiments described above. Therefore, the components of the photographing apparatus itself are given the same reference numerals as those in FIG. 1, but they are not shown in figures, and description thereof will be omitted.

In the photographing apparatus 100 processing for adding flags corresponding to various functions, for example, processing for adding an album registration flag, a printing reservation flag or the like is similar to that in the first embodiment described above (see FIGS. 2 and 3).

Deletion prohibition registration processing and deletion prohibition release processing in the photographing apparatus 100 are basically similar to those in the first embodiment described above (see FIGS. 4 and 5). However, in the present embodiment, a “not-deletable” flag set or cleared by the deletion prohibition registration processing or the deletion prohibition release processing executed by a “not-deletable” flag setting function section 31f of a first CPU 31 is managed by an attribute list file generated separately from image files.

Furthermore, in the photographing apparatus 100, transmission history information (a “transferred” flag) given by a “transferred” flag setting function section 31g of the first CPU 31 as a result of transfer processing by communication means (a wired communication control function section 31c and a wireless communication control function section 31b) being executed is also managed by the attribute list file. In the present embodiment, the transmission history information is first identification information identifying an image file transmitted to an external apparatus with the use of transmission means, and the transmission history information is stored in a storage medium 16 (image information storing means) from the first CPU 31 via the communication means (31b and 31c) which is transmission history giving means, as a file different from image files.

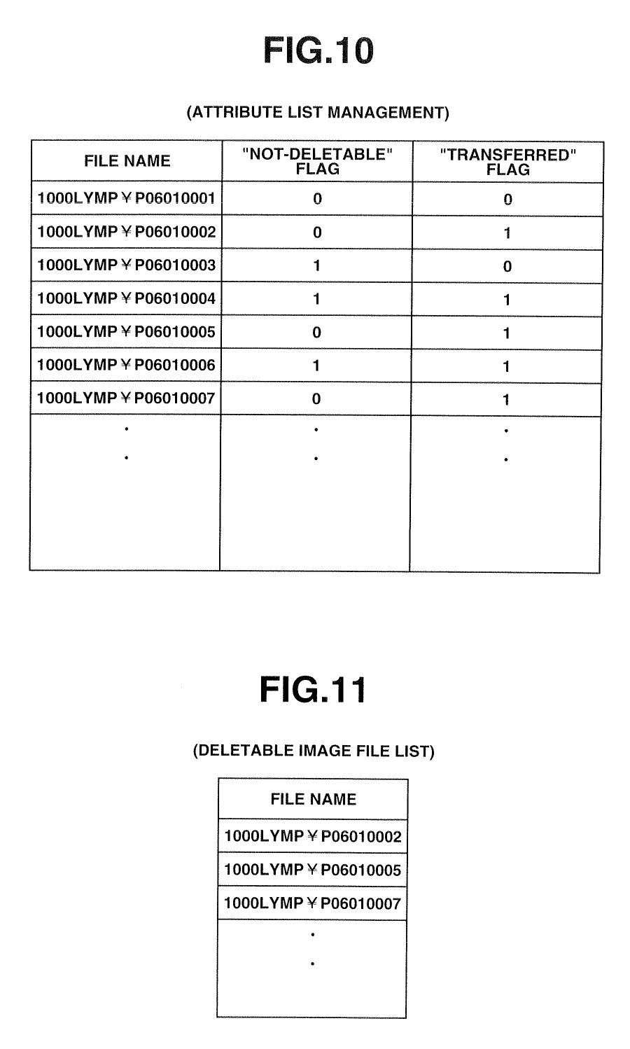

The attribute list file is, for example, a data file in a list form as shown in FIG. 10. Specifically, the attribute list file is a data file in which, for example, each of the filenames of image files stored in the storage medium 16 is shown in association with a set or cleared state of the “not-deletable” flag and the “transferred” flag, among related information corresponding to each image file, in a list form.

The attribute list file is automatically generated when transfer processing and various function processings are executed by the first CPU 31 as management information storing means which is a management information storing section, and the attribute list is stored in the storage area of the storage medium 16 as a file different from image files.

Then, by referring to only the attribute list file, the first CPU 31 can grasp and manage the attribute state of the image files stored in the storage medium 16.

That is, when necessary, the first CPU 31 controls a deletion target data checking function section 32e of a second CPU 32 to access a predetermined area of the storage medium 16 via a storage medium accessing section 32b, refer to the attribute list file stored in the storage medium 16 (image information storing means), and perform checking of image files having the “transferred” flag or the “not-deletable” flag and extraction of image files in the “deletable” state or in the “not-deletable” state.

Furthermore, in the present embodiment, a data file in which deletable image files are shown in a list form, for example, the deletable image file list file in a form as shown in FIG. 11 is automatically generated by the first CPU 31 on the basis of the attribute list file described above, as appropriate.

The condition of an image file being registered with the deletable image file list file is that the “transferred” flag is given to the image file but the “not-deletable” flag is not given in the attribute list file described above.

Similarly to each of the embodiments described above, the “not-deletable” flag is given on the basis of second identification information, such as the album registration flag and the printing reservation flag, which is given by specifying use by each application by use-by-application specifying means such as an album displaying function section 31d and a printing function section 31e.

By the “not-deletable” flag (second identification information) being described in the attribute list file, control is performed to prevent the image file identified by the flag from being deleted.

Next, the processing sequence of image file transfer processing in the photographing apparatus 100 will be described below.

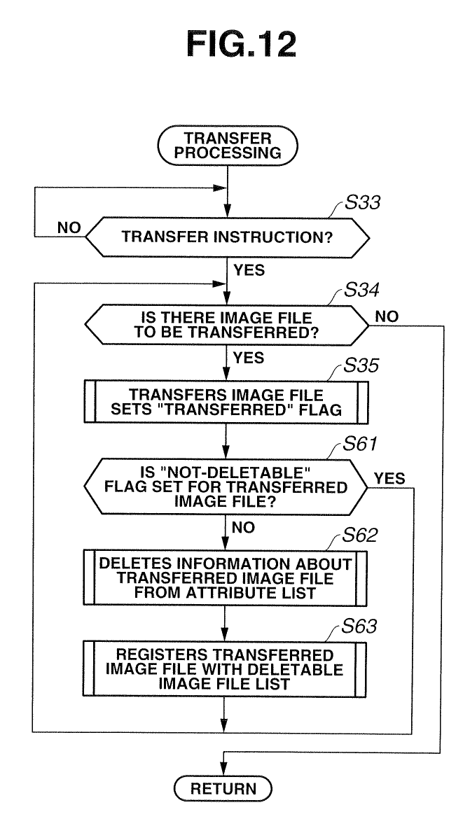

FIG. 12 is a flowchart shouting the flow of the image file transfer processing in the photographing apparatus including the image storage device of the present embodiment.

By the mode being switched to the image file transfer mode by a predetermined operation by a user when the photographing apparatus 100 is activated in the reproduction mode, execution of the image file transfer processing is started.

In the present embodiment, a series of processings from step S33 to step S35 in FIG. 12 is almost same as the series of processings from step S33 to step S35 in the image file transfer processing sequence in the second embodiment described above.

That is, at step S33 in FIG. 12, the first CPU 31 enters a waiting state for monitoring an image file transfer instruction signal. When the transfer instruction signal is confirmed, the first CPU 31 proceeds to processing at a next step S34.

At step S34, the first CPU 31 searches the attribute list file stored in the storage medium 16 to check whether or not an image file to be transferred exists (whether or not an image file for which the “transferred” flag is not set exists). If it is confirmed here that an image file to be transferred exits, the first CPU 31 proceeds to processing at step S35. If it is confirmed here that an image file to be transferred does not exist, the first CPU 31 ends the processing sequence of the series of transfer processings (return).

Next, at step S35, the first CPU 31 executes processing for actually transferring the image file to be transferred with the use of the communication means. When the processing is completed, the first CPU 31 controls the “transferred” flag setting function section 31g to execute processing for giving (setting) the “transferred” flag to (for) a field corresponding to the image file in the attribute list file. After that, the first CPU 31 proceeds to processing at step S61.

At step S61, the first CPU 31 searches the attribute list file to check whether or not the “not-deletable” flag is set for the image file transferred by the transferring operation performed immediately before. If it is confirmed that the “not-deletable” flag is set, the first CPU 31 returns to the processing at step S34 and repeats the subsequent processing.

On the other hand, if it is confirmed that the “not-deletable” flag is not set, the first CPU 31 proceeds to processing at step S62.

At step S62, the first CPU 31 performs processing for deleting information about the transferred image file from the attribute list file, and rewrites and updates the attribute list file. After that, the first CPU 31 proceeds to processing at step S63.

At step S63, the first CPU 31 performs processing for registering the information about the transferred image file with the deletable image file list file, and performs rewriting and update of the deletable image file list file. After that, the first CPU 31 returns to the processing at step S34 and repeats the subsequent processing.

In this way, the attribute list file and the deletable image file list file are generated.

Next, the processing sequence of a photographing operation in the photographing apparatus 100 will be described below.

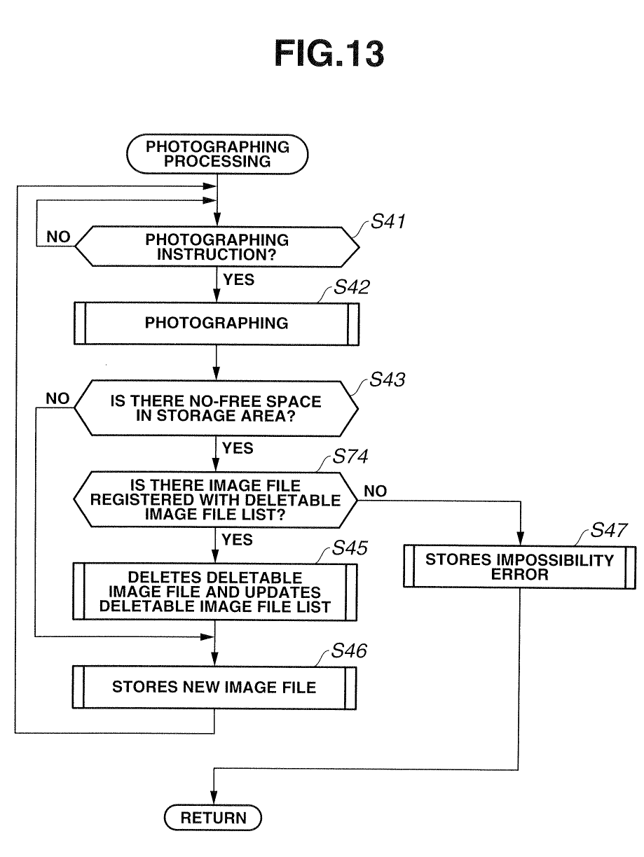

FIG. 13 is a flowchart showing the flow of the photographing operation processing in the photographing apparatus including the image storage device of the present embodiment.

The photographing operation processing in the photographing apparatus 100 of the present embodiment is almost same as the photographing operation processing in the second embodiment described above. The photographing apparatus 100 is different only in that, when there is no-free space in the storage area of the storage medium 16 after the photographing operation is performed, whether or not there is a deletable image file is checked by checking a deletable image file list (processing at step S74 in FIG. 13).

Other processing steps are quite the same as those in the second embodiment described above (see FIG. 8).

As described above, the advantages similar to those of the first embodiment described above can be also obtained in the fourth embodiment described above. Furthermore, a part of related information about image files stored in the storage medium 16 is managed by an attribute list file and a deletable image file list file generated on the basis of the attribute list file, and the list files are stored in the storage medium 16 as files different from image files. Therefore, it is sufficient to search only the list files when predetermined related information (the “not-deletable” flag, the “transferred” flag) is searched, and thereby, it is possible to obtain a search result faster.

The present invention is not limited to the embodiments described above. It is possible, of course, to implement various variations and applications within the range not departing from the spirit of the invention. The present invention is only limited by the accompanying claims but is not restricted by any particular embodiment thereof. Furthermore, the embodiments described above include various stages of the invention, and various inventions can be extracted by appropriate combination of multiple components disclosed. For example, in the case where the problems stated in the paragraphs of the problem to be solved by the invention can be solved and the advantages stated in the advantage of the invention can be obtained even if some of components are deleted from all the components shown in one of the embodiments described above, the configuration from which the components are deleted can be extracted as an invention.

What is claimed is:

1. An image storage device comprising:
an image information storing section for storing an image file;
a processing section for executing an application which uses an image file stored in the image information storing section;
a use-by-application specifying section for specifying a use of an image file stored in the image information storing section by the application;
a transmitting section for transmitting an image file stored in the image information storing section to an external apparatus;
a remaining-capacity-of-medium detecting section for detecting the remaining storage capacity of the image information storing section;
a deletion specifying section for specifying an image file which has already been transmitted to an external apparatus by the transmitting section and which is not specified to be used by the application, as a deletion target; and
a deleting section for, when the remaining storage capacity of the image information storing section is a predetermined amount or less, deleting the image file specified as a deletion target from among image files stored in the image information storing section.

2. The image storage device according to claim 1, further comprising:
a transmission history giving section for giving an image file transmitted to the external apparatus by the transmitting section, a first mark indicating that the image file has been transmitted; and
a use information giving section for giving a second mark to an image file specified by the use-by-application specifying section; wherein
the deletion specifying section specifies the image file to which the first mark is given but the second mark is not given, as a deletion target.

3. The image storage device according to claim 2, further comprising:
a use-by-application specification releasing section for deleting the second mark from an image file stored in the image information storing section.

4. The image storage device according to claim 1, further comprising:
a management information storing section for storing management information about image files stored in the image information storing section; and
a transmission history giving section for storing first identification information which identifies an image file transmitted by the transmitting section into the management information storing section; wherein
the use-by-application specifying section stores second identification information which identifies an image file specified to be used by the application into the management information storing section; and
the deletion specifying section specifies an image file which is identified by the first identification information stored in the management information storing section but is not identified by the second identification information, as the deletion target image file.

5. The image storage device according to claim 4, further comprising:
a use-by-application specification releasing section for deleting the second identification from the management information storing section.

6. The image storage device according to claim 1, wherein
the application includes at least one of an album displaying function of specifying any image file from among multiple image files stored in the image information storing section and displaying an image based on the specified image file at a predetermined position on a screen and a printing reserving function of specifying any image file from among the multiple image files stored in the image information storing section and reserving printing of an image based on the specified image file.

7. A photographing apparatus comprising:
a photographing section for photographing a subject and generating an image signal;
an image information storing section for storing an image file constituted by an image signal acquired from the photographing section and related information into a storage medium;
a processing section for executing an application which uses an image file stored in the image information storing section;
a use-by-application specifying section for specifying use of an image file stored in the image information storing section by the application;
a transmitting section for transmitting an image file stored in the image information storing section to an external apparatus;
a remaining-capacity-of-medium detecting section for detecting the remaining storage capacity of the image information storing section:
a deletion specifying section for specifying an image file which has already been transmitted to an external apparatus by the transmitting section and which is not specified to be used by the application, as a deletion target; and
a deleting section for, when the remaining storage capacity of the image information storing section is a predetermined amount or less, deleting the image file specified as a deletion target from among image files stored in the image information storing section.

8. A control method for controlling an image storage device which includes an image information storing section and a processing section for executing application software, the control method comprising:
a use specifying step of giving an image file stored in the image information storing section, use specification information which specifies the image file to be used by application software executed by the processing section;
a transmitting step of transmitting an image file stored in the image information storing section to an external apparatus:
a transmission history giving step of giving the image file transmitted to the external apparatus at the transmitting step, transmitted information indicating that the image file has been transmitted;
a remaining-capacity-of-medium detecting step of detecting the remaining storage capacity of the image information storing section;
a first deleting step of when the remaining storage capacity of the image information storing section is a predetermined amount or less, deleting an image file which has the transmitted information given at the transmission history giving step and which is not given the use specification information;
a specification releasing step of deleting the use specification information from an image file stored in the image information storing section; and
a second deleting step of deleting the image file from which the use specification information has been deleted at the specification releasing step and to which the transmitted information is given.

9. The control method according to claim 8, wherein
the transmission history giving step gives a first mark to the image file transmitted at the transmitting step;
the use-by-application specifying step gives the image file a second mark which specifies the image file to be used by the application;
the specification releasing step deletes the second mark from the image file; and
the second deleting step deletes an image file from which the second mark has been deleted and to which the first mark is given.
